(19) United States
(12) Patent Application Publication
(10) Pub. No.: US 2011/0292005 A1
(43) Pub. Date: Dec. 1, 2011

(54) DISPLAY APPARATUS AND METHOD FOR ELIMINATING GHOST THEREOF

(75) Inventors: Chee-Wai LAU, Hsin-Chu (TW); Yu-Hsin Ting, Hsin-Chu (TW); Chung-Lin Fu, Hsin-Chu (TW); Wei-Chun Hsu, Hsin-Chu (TW); Nan-Ying Lin, Hsin-Chu (TW); Fu-Yuan Liou, Hsin-Chu (TW)

(73) Assignee: AU OPTRONICS CORP., HSINCHU (TW)

(21) Appl. No.: 12/940,765

(22) Filed: Nov. 5, 2010

(30) Foreign Application Priority Data
Jun. 1, 2010 (TW) 099117665

(51) Int. Cl. G09G 5/00

(52) U.S. Cl. 345/204

(57) ABSTRACT

A display apparatus includes a plurality of scan lines, a plurality of data lines, a plurality of pixel transistors, a plurality of pixel electrodes, a gate driver, a source driver and a discharge circuit. The data lines are intersected with the scan lines. Each of the pixel transistors is electrically coupled to a corresponding scan line and a corresponding data line, and each of the pixel electrodes is electrically coupled to a corresponding pixel transistor. The gate driver is electrically coupled to the scan lines, and the source driver is electrically coupled to the data lines. The discharge circuit is electrically coupled to the gate driver and the data lines. The discharge circuit starts when the display apparatus is turned off, to control the gate drive for turning on the pixel transistors simultaneously, and make the pixel electrodes be electrically communicated with a reference voltage.

### BACKGROUND

1. Technical Field

The present invention relates to the display field and, particularly to a display apparatus and a method for eliminating ghost thereof.

2. Description of the Related Art

With the rapid development of the science and technology, since a flat-display apparatus (such as, liquid crystal display) has many advantages, such as high image quality, little size, light weight and wide application-range, etc., it is widely applied into various consumer electronics products, such as mobile phone, notebook computer, desktop display apparatus and television, etc., and therefore has gradually substituted conventional cathode ray tube (CRT) display apparatus to be a main trend of the display apparatus.

It is well known that a conventional flat-display apparatus employs a gate driver to enable pixels of a display panel in sequence and employs a source driver to output display data to the pixels of the display panel, such that the flat-display apparatus displays an image. However, when the flat-display apparatus is turned off, especially when the flat-display apparatus is turned off abnormally because of cutting off the power source suddenly, charges in the pixels of the display panel cannot be rapidly released, causing a ghost image (residual image) phenomenon and thus influencing the display quality of the flat-display apparatus.

### BRIEF SUMMARY

The present invention relates to a display apparatus, which can eliminate ghost image phenomenon.

The present invention also relates to a method for eliminating ghost image of a display apparatus, which can eliminate the ghost image of the display apparatus.

A display apparatus in accordance with an exemplary embodiment of the present invention comprises a plurality of scan lines, a plurality of data lines, a plurality of pixel transistors, a plurality of pixel electrodes, a gate driver, a source driver and a discharge circuit. The data lines are intersected with the scan lines. Each of the pixel transistors is electrically coupled to a corresponding one of the scan lines and a corresponding one of the data lines, and each of the pixel electrodes is electrically coupled to a corresponding one of the pixel transistors. The gate driver is electrically coupled to the scan lines, and the source driver is electrically coupled to the data lines. The discharge circuit is electrically coupled to the gate driver and the data lines. The discharge circuit starts, when the display apparatus is turned off, to control the gate drive for turning on the pixel transistors simultaneously and make the pixel electrodes be electrically coupled to a reference voltage through the data lines and the discharge circuit.

In an exemplary embodiment of the present invention, the discharge circuit comprises a control-signal source and a charge-releasing circuit. The control-signal source is electrically coupled to the gate driver and configured for supplying a control signal to control the gate driver for enabling the scan lines simultaneously to turn on the pixel transistors. The charge-releasing circuit is electrically coupled between the data lines and the reference voltage to make the pixel electrodes be electrically coupled to the reference voltage through the data lines when the pixel transistors are turned on simultaneously.

In an exemplary embodiment of the present invention, the gate driver comprises a plurality of first switches. Each of the first switches is electrically coupled to a corresponding one of the scan lines and is controlled by the control signal sent from the control-signal source, such that each of the first switches is turned on to enable the corresponding scan line when the display apparatus is turned off.

In an exemplary embodiment of the present invention, the charge-releasing circuit comprises a plurality of second switches. Each of the second switches is electrically coupled between the reference voltage and a corresponding one of the data lines, such that each of the second switches is turned on when the display apparatus is turned off. Preferably, each of the second switches is controlled by the control signal sent from the control-signal source.

A display apparatus in accordance with another exemplary embodiment of the present invention comprises a display panel having a plurality of pixels, a gate driver, a source driver and a discharge circuit. The gate driver is electrically coupled to the display panel to determine whether enabling each of the pixels. The source driver is electrically coupled to the display panel to input data to the enabled pixel(s). The discharge circuit is electrically coupled to the gate driver and the display panel. The discharge circuit starts to control the gate driver for enabling the pixels of the display panel when the display apparatus is turned off and make the pixels be electrically coupled to a reference voltage for discharging the pixels.

In an exemplary embodiment of the present invention, the discharge circuit comprises a control-signal source and a charge-releasing circuit. The control-signal source is electrically coupled to the gate driver and configured for supplying a control signal to control the gate driver for enabling the pixels simultaneously. The charge-releasing circuit is electrically coupled between the display panel and the reference voltage to make the pixels be electrically coupled to the reference voltage for discharging the pixels when the pixels are enabled simultaneously.

A method for eliminating a ghost image of a display apparatus in accordance with still another exemplary embodiment of the present invention is provided. The display apparatus comprises a display panel having a plurality of pixels, and the display panel comprises a plurality of data lines to supply display data to the pixels. The method comprises steps of: judging whether the display apparatus is turned off; and enabling the pixels of the display panel simultaneously and making the pixels be electrically coupled to a reference voltage through the data lines when the display apparatus is judged to be turned off.

In an exemplary embodiment of the present invention, the method for eliminating a ghost image of a display apparatus further comprises steps of: supplying a first control signal to the display panel for enabling the pixels of the display panel simultaneously when the display apparatus is turned off; and supplying a second control signal to the display panel for making the data lines be electrically coupled to the reference voltage. Preferably, the first control signal and the second control signal are a same signal.

The display apparatus and the method for eliminating a ghost image of the present invention can employ the discharge circuit to rapidly remove the residual charges of each of the pixels of the display panel, and therefore the ghost image phenomenon in the prior art can be effectively eliminated.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a display apparatus in accordance with an exemplary embodiment of the present invention.

FIG. 2 is a timing sequence view of various signals of the display apparatus as shown in FIG. 1.

FIG. 3 is a flow chart of a method for eliminating a ghost image of a display apparatus in accordance with an exemplary embodiment of the present invention.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. Accordingly, the descriptions will be regarded as illustrative in nature and not as restrictive.

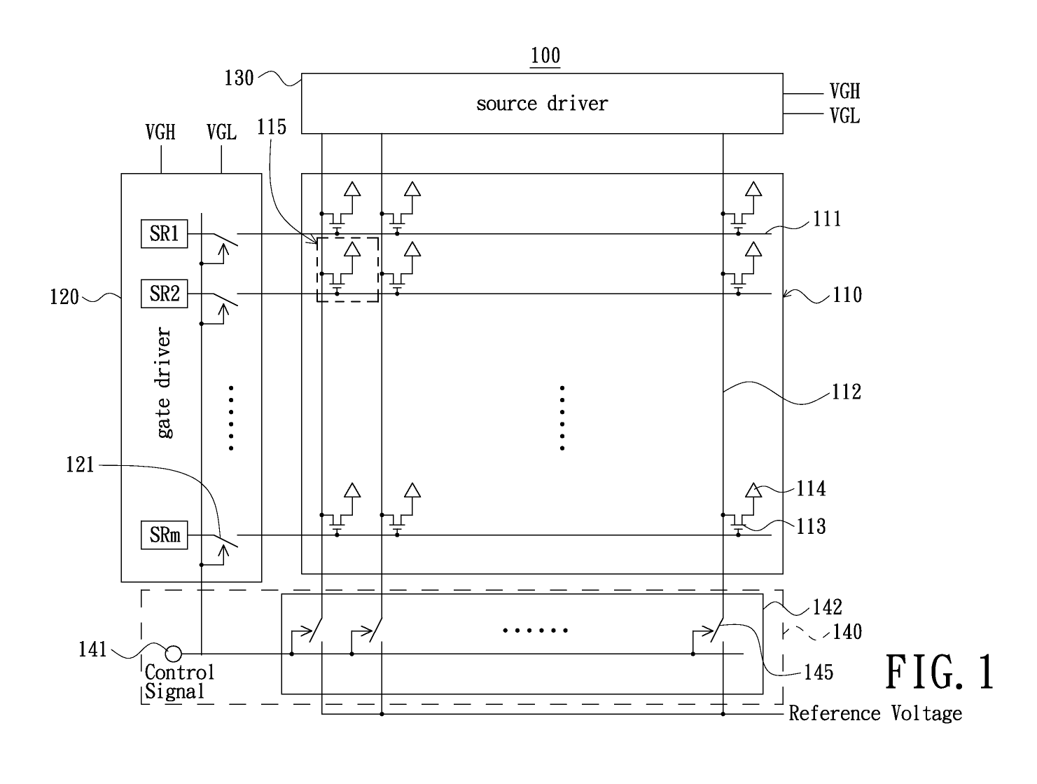

Refer to FIG. 1, which is a schematic view of a display apparatus in accordance with an exemplary embodiment of the present invention. The display apparatus may be a flat-display apparatus, such as liquid crystal display apparatus. As shown in FIG. 1, the display apparatus 100 comprises a display panel 110, a gate driver 120, a source driver 130 and a discharge circuit 140.

In detail, the display panel 110 has a plurality of scan lines 111, a plurality of data lines 112, a plurality of pixel transistors 113 and a plurality of pixel electrodes 114. The scan lines 111 are intersected (i.e., generally arranged crossing) with the data lines 112 to divide the display panel 110 into a plurality of pixels 115. The pixel transistors 113 and the pixel electrodes 114 are distributed into the pixels 115. The pixel transistor 113 in each of the pixels 115 is electrically coupled to a corresponding one of the scan lines 111 and a corresponding one of the data lines 112, and the pixel electrode 114 in each of the pixels 115 is electrically coupled to the pixel transistor 113 in this pixel 115.

The gate driver 120 is electrically coupled to the scan lines 111 of the display panel 110 to enable the scan lines 111 in sequence (or other manner), such that the pixel transistors 113 turn on in sequence. The source driver 130 is electrically coupled to the data lines 112 of the display panel 110, for inputting image/display data into corresponding pixel electrodes 114 through the respective data lines 112 and the turned-on pixel transistors 113. In addition, the display apparatus 100 provides a high voltage VGH and a low voltage VGL to the gate driver 120 and the source driver 130 after it starts, thus the gate driver 120 and the source driver 130 perform normal operations.

The discharge circuit 140 comprises a control-signal source 141 and a charge-releasing circuit 142. The control-signal source 141 is electrically coupled to the gate driver 120 to supply a control signal to the gate driver 120. Therefore, when the display apparatus 100 is turned off, the control signal controls the gate driver 120 to enable the scan lines 111 of the display panel 100 simultaneously to turn on the corresponding pixel transistors 113 simultaneously. The charge-releasing circuit 142 is electrically coupled between the data lines 112 of the display panel 110 and a reference voltage, such that the pixel electrodes 114 are electrically communicated with the reference voltage through the data lines 112 when turning on the pixel transistors 113 simultaneously.

In detail, the gate driver 120 may comprise a plurality of first switches 121. Each of the first switches 121 is electrically coupled to a corresponding one of the scan lines 111. When the display apparatus 100 is in a normal operation state, the first switches 121 will normally turn on in sequence. In other words, the first switches 121 may be also controlled by shift registers SR1, SR2˜SRm of the gate driver 120 respectively, such that the first switches 121 turns on in sequence to enable the scan lines 111 of the display panel 110 in sequence when the display apparatus 100 performs the normal operation, for ensuring the display apparatus 100 to perform the normal operation.

When the display apparatus 100 is turned off or suddenly powers off, the first switches 121 are further controlled by the control signal sent from the control-signal source 141, such that the first switches 121 turns on simultaneously. The data in the scan lines 111 originally outputted by the shift registers SR1, SR2˜SRm are enabled, such that the corresponding pixel transistors 113 turn on. On the other hand, other circuit may be employed to provide a specific signal to the scan lines 111 instead when the display apparatus 100 is turned off, such that the corresponding pixel transistors 113 turn on through the scan lines 111.

In addition, it is understood for persons skilled in the art that the present invention can only alter the software configuration of the gate driver without altering the hardware configuration of a conventional gate driver to make the gate driver 120 enable the scan lines 111 of the display panel 110 simultaneously when the control signal sent from the control-signal source 141 indicates the display apparatus 100 is turned off, such that the pixel transistors 113 of the display panel 110 turns on simultaneously.

In the exemplary embodiment, the charge-releasing circuit 142 comprises a plurality of second switches 145. Each of the second switches 145 is electrically coupled between a corresponding one of the data lines 112 and the reference voltage. Each of the second switches 145 is also controlled by the control signal sent from the control-signal source 141 to be turned on simultaneously when the display apparatus 100 is turned off, such that the pixel electrodes 114 of the display panel 110 are electrically communicated with the reference voltage through the turned-on pixel transistors 113, the data lines 112, and the turned-on second switches 145. Therefore, each of the pixels 115 of the display panel 110 discharges through the above electrical route, to remove/release the residual charge of the pixel electrodes 114, for eliminating the residual/ghost image of the display apparatus 100.

In addition, it is understood for persons skilled in the art that, although the first switches 121 and the second switches 145 are controlled by the same control-signal source 141 in the exemplary embodiment, the first switches 121 and the second switches 145 may be controlled by different control-signal sources respectively instead. Furthermore, the reference voltage may be any predetermined voltage, such as the common voltage of the display apparatus 100.

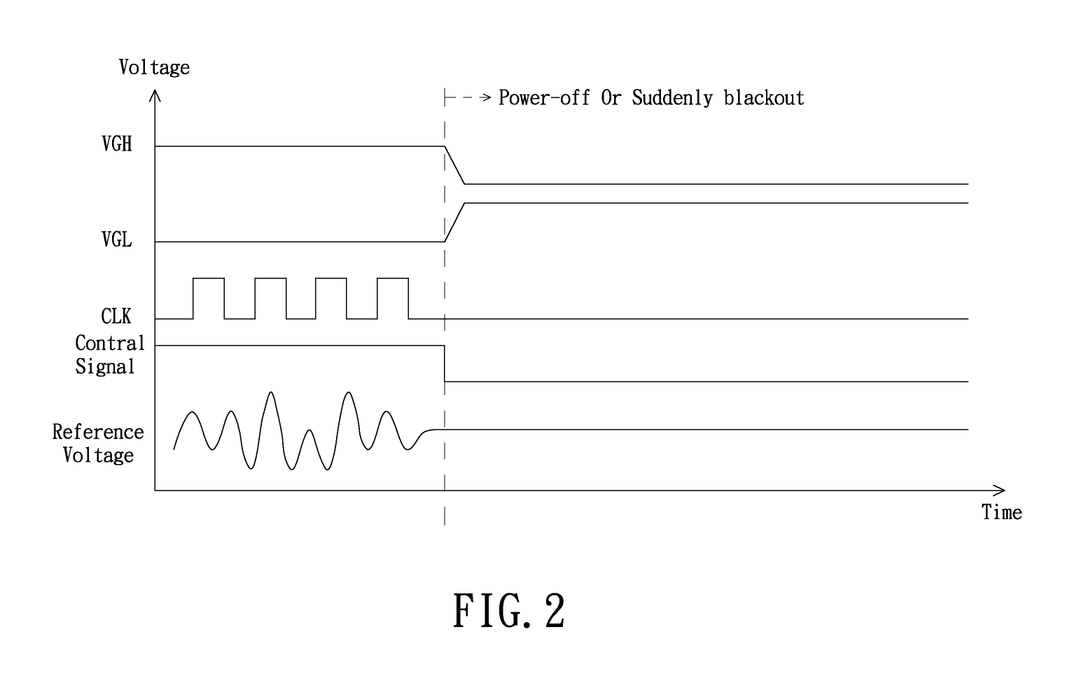

Then refer to FIG. 2, which is a timing sequence view of various signals of the display apparatus as shown in FIG. 1. As shown in FIG. 2, when the display apparatus 100 is turned off caused by power-off or suddenly blackout, the high voltage VGH and the low voltage VGL of the gate driver 120 and the source driver 130 will alter. At the moment, the display apparatus 100 will stop to send out the clock-pulse signal CLK. The control signal sent from the control-signal source 141 is altered from a first potential (such as a logic high potential) to a second potential (such as a logic low potential), to control the gate driver 120 for enabling the gate lines 111 of the display panel 110 simultaneously and thereby turning on the corresponding pixel transistors 113, and to make the data lines 112 of the display panel 110 be electrically communicated with the reference voltage to discharge the pixel electrodes 114.

Furthermore, as shown in FIG. 2, since the display apparatus 100 performs the normal operation, the discharge circuit 140 is in the non-operation state. Therefore, the value of the reference voltage is not limited during the above normal operation period. The present invention only expects that the reference voltage is a predetermined voltage such as the common voltage, when the display apparatus 100 is turned off.

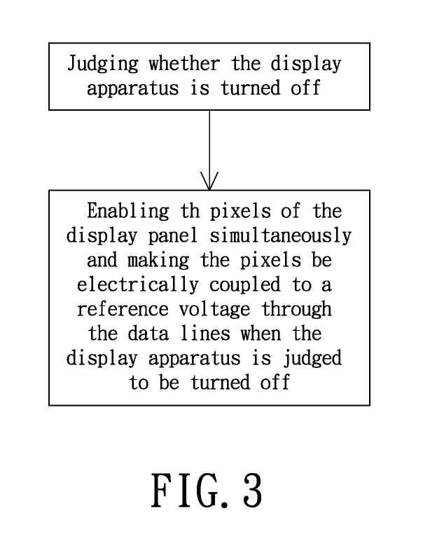

In addition, the present invention also provides a method for eliminating a ghost image, which is applied into the display apparatus 100 as shown in FIG. 1. Refer to FIG. 3, which is a flow chart of the method for eliminating the ghost image of the display apparatus in accordance with an exemplary embodiment of the present invention. As shown in FIG. 3, the method for eliminating the ghost image comprises steps of: judging whether the display apparatus 100 is turned off; enabling the pixels 115 (i.e., generally turning on the pixel transistors 113) of the display apparatus 100 and making the pixels 115 to be electrically communicated with the reference voltage through the data lines 111. In detail, the present invention can provide the first control signal to enable the pixels 115 of the display panel 110 simultaneously when the display apparatus 100 is turned off; and provide the second control signal to make the data lines 112 of the display panel 110 be electrically communicated with the reference voltage. Preferably, both of the first control signal and the second control signal may be the same control signal sent from the control-signal source 141.

In summary, the display apparatus and the method for eliminating the ghost image of the present invention can employ the discharge circuit to rapidly remove/release the residual charges of each of the pixels of the display panel, and therefore can effectively the ghost image of display apparatus in the prior art.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A display apparatus comprising:
a plurality of scan lines;
a plurality of data lines arranged crossing with the scan lines;
a plurality of pixel transistors, each of the pixel transistors being electrically coupled to a corresponding one of the scan lines and a corresponding one of the data lines;
a plurality of pixel electrodes, each of the pixel electrodes being electrically coupled to a corresponding one of the pixel transistors;
a gate driver electrically coupled to the scan lines;
a source driver electrically coupled to the data lines; and
a discharge circuit electrically coupled to the gate driver and the data lines;
wherein the discharge circuit starts to operate when the display apparatus is turned off, and thereby the gate driver is controlled to simultaneously turn on the pixel transistors and the pixel electrodes are allowed to be electrically coupled to a reference voltage through the data lines and the discharge circuit.

2. The display apparatus as claimed in claim 1, wherein the discharge circuit comprises:
a control-signal source electrically coupled to the gate driver and configured for supplying a control signal to control the gate driver for enabling the scan lines simultaneously to turn on the pixel transistors; and
a charge-releasing circuit electrically coupled between the data lines and the reference voltage to allow the pixel electrodes to be electrically coupled to the reference voltage through the data lines when the pixel transistors are turned on.

3. The display apparatus as claimed in claim 2, wherein the gate driver comprises:
a plurality of first switches, each of the first switches being electrically coupled to a corresponding one of the scan lines and being controlled by the control signal sent from the control-signal source to be turned on for enabling the corresponding scan line when the display apparatus is turned off.

4. The display apparatus as claimed in claim 2, wherein the charge-releasing circuit comprises:
a plurality of second switches, each of the second switches being electrically coupled between the reference voltage and a corresponding one of the data lines, such that each of the second switches is turned on when the display apparatus is turned off.

5. The display apparatus as claimed in claim 4, wherein each of the second switches is controlled by the control signal sent from the control-signal source.

6. A display apparatus comprising:
a display panel having a plurality of pixels;
a gate driver electrically coupled to the display panel to determine whether enabling each of the pixels;
a source driver electrically coupled to the display panel to input data to the enabled pixel(s); and
a discharge circuit electrically coupled to the gate driver and the display panel;
wherein the discharge circuit starts to control the gate driver to simultaneously enable the pixels of the display panel when the display apparatus is turned off, and makes the pixels be electrically coupled to a reference voltage for discharging the pixels.

7. The display apparatus as claimed in claim 6, wherein the discharge circuit comprises:
a control-signal source electrically coupled to the gate driver and configured for supplying a control signal to control the gate driver for enabling the pixels simultaneously; and
a charge-releasing circuit electrically coupled between the display panel and the reference voltage to make the pixels be electrically coupled to the reference voltage for discharging the pixels when the pixels are enabled simultaneously.

8. A method for eliminating a ghost image of a display apparatus, the display apparatus comprising a display panel having a plurality of pixels, the display panel comprising a plurality of data lines to supply display data to the pixels, the method comprising:
a step A: judging whether the display apparatus is turned off; and
a step B: enabling the pixels of the display panel simultaneously and making the pixels be electrically coupled to a reference voltage through the data lines when the display apparatus is judged to be turned off.

9. The method for eliminating a ghost image of a display apparatus as claimed in claim 8, wherein the step B comprises:
a step B1: supplying a first control signal to the display panel for enabling the pixels of the display panel simultaneously when the display apparatus is turned off; and
a step B2: supplying a second control signal to the display panel for making the data lines be electrically coupled to the reference voltage.

10. The method for eliminating a ghost image of a display apparatus as claimed in claim 9, wherein the first control signal and the second control signal are a same signal.
